(19) United States
(12) Patent Application Publication
(10) Pub. No.: US 2019/0187634 A1
(43) Pub. Date: Jun. 20, 2019

(54) MACHINE LEARNING CONTROL OF ENVIRONMENTAL SYSTEMS

(71) Applicant: MIDEA GROUP CO., LTD, Foshan (CN)

(72) Inventors: Yi Fan, Union City, CA (US); Xiaochun Li, San Ramon, CA (US)

(21) Appl. No.: 15/843,580

(22) Filed: Dec. 15, 2017

(51) Int. Cl. G05B 13/02; G05B 19/042; F24F 11/64; F24F 11/65; F24F 11/56

(52) U.S. Cl. CPC G05B 13/0265; G05B 19/0426; F24F 11/64; H05B 37/0218; F24F 11/56; G05B 2219/2614; G05B 2219/2642; F24F 11/65

(57) ABSTRACT

Machine learning is used to control environmental systems for a building or other man-made structure. In one approach, environmental data is collected by sensors for an environment within the man-made structure. The environmental data is used as input to a machine learning model that predicts at least one attribute affecting control of the environment within the man-made structure. For example, the machine learning model might predict load on the environmental system, resource consumption by the environmental system, or cost of operating the environmental system. The environmental system for the man-made structure is controlled based on the predicted attribute.

### BACKGROUND

### 1. Technical Field

This disclosure relates generally to the control of environmental systems for man-made structures such as large buildings.

### 2. Description of Related Art

The efficient operation of the environmental systems for a building or other man-made structure is an important aspect of operating the building, both with respect to comfort of the occupants in the building and with respect to minimizing the operating cost and environmental impact of the building. However, there are many factors that affect the environment within the building and the operation of the environmental systems for the building. HVAC and lighting demands are affected by the activities occurring within the building, the time of day, the time of year, the weather and the influence of the external surroundings. Cost-effective operation of HVAC and lighting systems also depends on the rate schedules for the resources consumed by these systems and on effective load balancing. In addition, the task of intelligently controlling these environmental systems is more complex for larger and more complex buildings.

However, the ability to control environmental systems in an intelligent manner is typically limited. Temperature control often is limited to the manual setting of a thermostat or a manually programmed schedule that varies the thermostat setting over the course of a week. Similar controls may be used for air circulation and air filtration systems. Lighting control is also often limited to manual switches or, in some cases, lighting may be controlled by motion detectors that turn on lights when motion is detected within a room and turn off lights when motion is no longer detected. All of these controls are fairly basic in their capabilities.

Thus, there is a need for more effective approaches to controlling environmental systems.

### SUMMARY

The present disclosure overcomes the limitations of the prior art by using machine learning to control environmental systems. In one approach, environmental data is collected by sensors for an environment within a man-made structure. The environmental data is used as input to a machine learning model that predicts at least one attribute affecting control of the environment within the man-made structure. For example, the machine learning model might predict load on the environmental system, resource consumption by the environmental system, or cost of operating the environmental system. The environmental system for the man-made structure is controlled based on the attribute predicted by the machine learning model.

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a block diagram of a system for controlling an environmental system, according to an embodiment.

FIGS. 2A-2C are screen shots of a mobile app used to collect feedback from occupants, according to an embodiment.

FIGS. 3A and 3B are a diagram illustrating a high-level flow for controlling an environmental system, according to an embodiment.

FIG. 4 is a screen shot of an operator user interface, according to an embodiment.

FIG. 5 is a flow diagram illustrating training and operation of a machine learning model, according to an embodiment.

FIG. 6 is a block diagram of another system for controlling an environmental system, according to an embodiment.

### DETAILED DESCRIPTION OF THE PREFERRED EMBODIMENTS

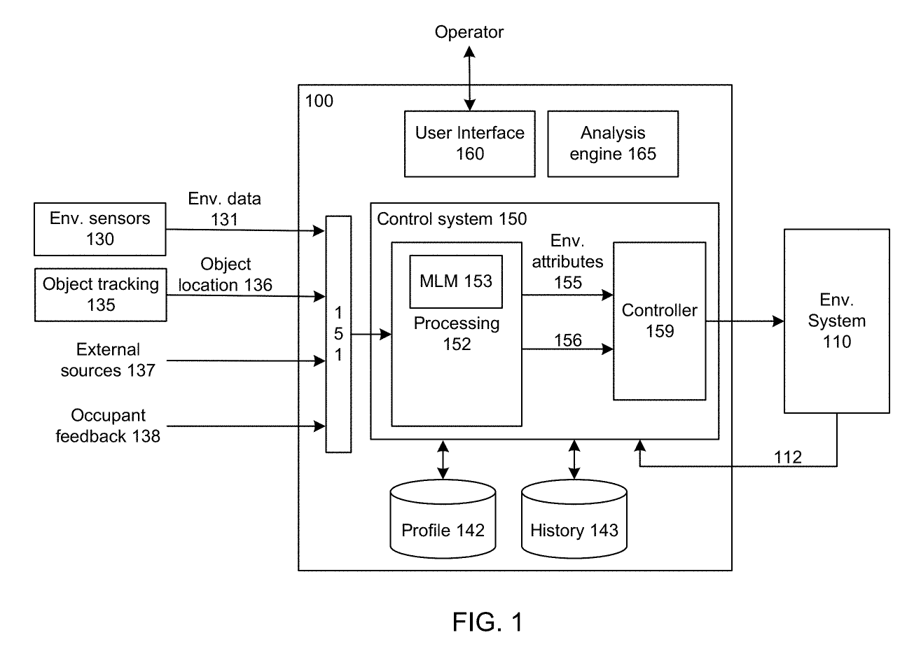

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed. FIG. 1 is a block diagram of a system 100 for controlling an environmental system 110 for a man-made structure, according to one embodiment. The environmental system 110 adjusts the environment within the man-made structure. Examples of man-made structures include buildings and groups of buildings such as a company or university campus. The system 100 is especially beneficial for larger and more complex structures, such as commercial buildings, public buildings, and buildings with many floors (e.g., at least 5 floors) or many rooms (e.g., at least 20 rooms).

Examples of environmental system 110 include HVAC systems (heating system, ventilation system, cooling or air conditioning system), air circulation and air filtration systems, and artificial lighting systems. Environmental system 110 could also include systems that regulate the effect of the external surroundings on the man-made structure, for example the amount of external light that enters the man-made structure or heating and/or cooling of the man-made structure by the external surroundings.

The system 100 includes a data interface 151 and control system 150. The control system includes processing capability 152, which includes a machine learning model 153, and a controller 159. As used herein, the term “machine learning model” is meant to include just a single machine learning model or also an ensemble of machine learning models. Each model in the ensemble may be trained to infer different attributes. The data interface 151 receives various input data, which are processed 152 at least in part by the machine learning model 153. The results 155, 156 are input to the controller 159, which controls the environmental system 110 accordingly.

The control system 150 can receive various types of inputs, and from various sources. This includes environmental data 131 captured by sensors 130 that monitor the environment within the man-made structure. Examples include temperature, humidity, pressure and air quality data. Air quality might include the concentration of allergens or of particulates of a certain size. It might also include the detection of certain substances: carbon monoxide, smoke, fragrances, negative ions, or other hazardous or desirable substances. Environmental data 131 can also include lighting levels and lighting color.

Other inputs 136 concern objects inside the man-made structure. These objects could be humans or animals, or they could be inanimate objects. Tracking 135 of objects can be achieved by various methods. Cameras inside the structure, including both thermal and visible, can be used to capture images which are then analyzed for objects. Physical access ways, such as doorways, hallways, elevators and entrances/exists, may be fitted with sensors so that they track objects passing through the access way. If key card or other access control devices are required to gain access to certain spaces, objects can be tracked by tracking the use of those devices. As a final example, objects may carry trackable objects, such as RFID tags, WiFi or other wireless devices, and their movement may be tracked by tracking these objects.

Tracking the location 136 of objects in the building can be used to better control the environmental system 110. For example, tracking individuals can be used to determine spaces where activity is occurring and spaces where there is no activity, and the environments for those spaces can be controlled accordingly. In addition, individuals may have environmental preferences: warmer or brighter for some individuals and cooler or dimmer for other individuals. Knowing the individuals' locations 136 allows the control system 150 to accommodate these individual preferences. As a final example, certain objects may require a special environment: computer servers should be cooled, food should be kept at a certain temperature, or certain materials may be sensitive to light. Tracking their location can ensure that the correct environment is produced at the object's location and that no energy is wasted producing that environment at other locations.

External sources 137 can also provide information to the control system 150. Generally, information will be relevant if it affects the environment within the structure or if it affects operation of the environmental system. Examples include the local weather forecast, the rate schedule for resources consumed by the environmental system (e.g., pricing for electricity, gas, coal, fuel oil, etc.), and the forecasted demand in the local area for these resources. These factors are considered by the control system 150 in order to improve operation of the environmental system 110.

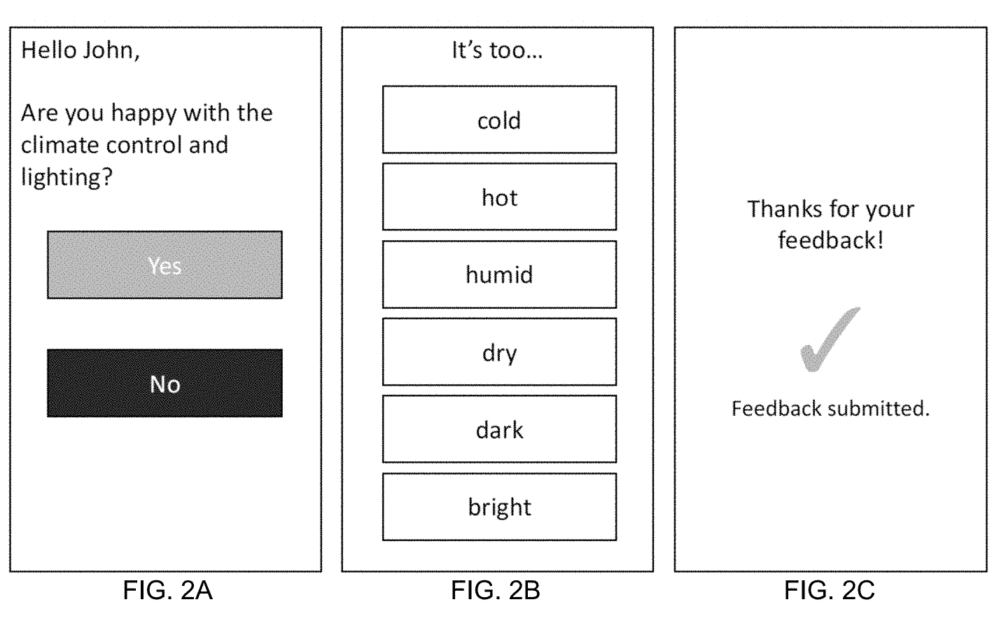

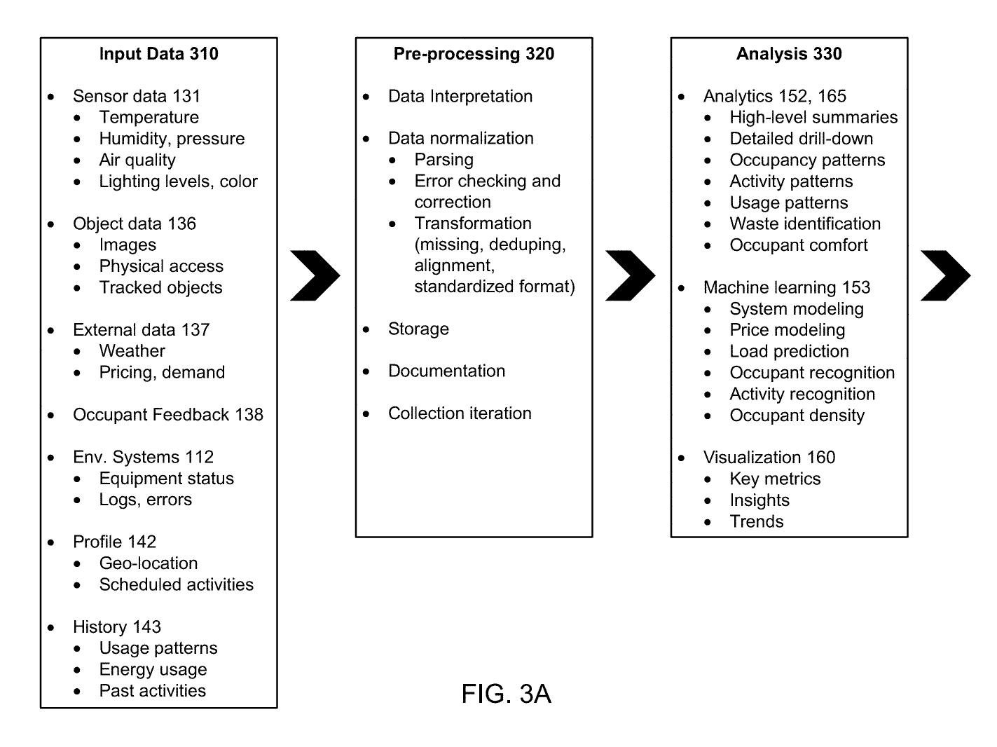

Occupants can also provide feedback 138. In one approach, location-based services and mobile devices are used to collect this feedback 138 from occupants. FIGS. 2A-2C are screen shots of a mobile app that accomplishes this. The screen of FIG. 2A asks the occupant whether he is satisfied with the current environment. If he is not, then the screen of FIG. 2B further asks what is not satisfactory about the current environment. The screen of FIG. 2C thanks the occupant for his feedback. Location services are used to determine the location of the occupant, so that his feedback can be tied to a location within the structure.

In FIG. 1, the control system 150 also receives information from the environmental system 110 itself and from data sources 142, 143. The environmental system 110 may provide data 112 about its operation: settings and rate of operation over time, status of the environmental system, and log files and errors/alerts.

Database 142 contains profile information for the man-made structure. This might be the geo-location of the structure, scheduled activities for the structure (e.g., planned shutdown during certain weeks, peak activities during certain weeks, scheduled meetings in various rooms throughout the day), and general preferences or rules to be applied. The profile information could be for the entire structure and/or for individual spaces or occupants for the structure. For example, there may be a scheduled holiday break for the entire structure, or for a company that occupies two floors of the structure, or for a specific individual who occupies one office. As another example, the default rule for the building might be to reduce lighting and HVAC services on the weekends, but an accounting firm might change this for their busy season leading up to their April 15 deadline.

Database 143 contains historical data. This could be historical data for operation of the environmental system 110, for preferences or profiles, or for any other factors described above.

The control system 150 receives these different data, processes 152 them and controls 159 the environmental system 110 accordingly. For an HVAC system, it may adjust the amount of heating or cooling provided. For air circulation and air filtration systems, the controller 159 may adjust fan speeds, the position of dampers and valves in the duct work, recirculation routes, or the amount or type of filtration. Lighting systems may be adjusted with respect to lighting level or lighting color. The controller 159 may also adjust interactions with the external surroundings. For example, lowering, retracting, or otherwise controlling shades, blinds, skylights and light pipes can be used to regulate the amount of sunlight that enters a building. This can be done for temperature purposes or for lighting purposes. Adjusting the mix of outside air and recirculated air can be used to control particulates, allergens, and air freshness.

The controller can implement certain strategies. There may be a distinction between “global” and “local” control, where “local” could be local in time or local in space. For example, the controller 159 might control the environmental system 110 to provide a general background environment for a building, such as maintaining spaces at 68 degrees during weekday working hours and at 62 degrees otherwise. It may further provide local or spot control of the environmental system to deviate from the general background environment based on the occurrence of specific conditions. For example, if a board meeting is scheduled for Tuesday afternoon and the board prefers a warmer environment, the board room may be pre-heated to 72 degrees in time for the board's arrival. Alternately, if the machine learning model 153 detects regular activity in the evenings for a certain wing of a building, the controller 159 may automatically extend the workday temperature of 68 degrees into the evening.

Machine learning models 153 are especially useful to predict attributes that are more difficult or cumbersome to develop using more conventional approaches. For example, the environmental data 131 may be used as input to the machine learning model 153, which then predicts various attributes 155 that affect control of the environment. The controller 159 then controls the environmental system according to these attributes. One example is that the machine learning model 153 may predict the load on the environmental system or on individual components in the environmental system. This could then be used for load balancing. Another example is that the machine learning model 153 might predict the resource consumption of the environmental system or the cost for operating the environmental system, or for components within the environmental system. The environmental system can then be controlled to reduce its resource consumption or cost. For example, the price of resources may fluctuate over time, both during the day and across the year, and the predictions from the machine learning model may be the basis to shift resource consumption to time periods with lower prices.

The use of machine learning is especially beneficial for situations where the predicted attribute is a complex function of many factors, or when there is a desire for the system to self-learn or self-monitor certain relationships. For example, the temperature in a room depends on the temperature of adjacent rooms, whether the heater is operating and how strongly, the amount of air circulation between rooms, the weather outside and the extent to which external air is mixed with internal air, and to what extent heat is gained or lost to the outside for example by the sun shining into the room or by radiation from the room to the cooler outside. This is just for one room. The temperatures for many rooms is an even more complex interrelated problem. Machine learning approaches can be used to learn these complex relationships.

As an example, perhaps it is desired for two rooms to be set a different temperatures: 66 degrees and 72 degrees. With manual control, people would set individual thermostats for each room. The cooling system would attempt to cool one room to 66 degrees, and the heating system would attempt to heat the other room to 72 degrees. However, the independently operating air circulation system may be mixing and recirculating the air from the two rooms, effectively making the heating and cooling systems work against each other. Machine learning may learn this and then automatically set dampers in the air circulation system to thermally separate the air flow for the two rooms.

In addition, these complex relationships may change over time as summer transitions to winter, as spaces are allocated to different tenants or to different functions over time, or as prices for electricity, gas and other resources fluctuate. Even if it were possible to expressly construct a model to regulate room temperature, it may be desirable for machine learning techniques to automatically adapt to changes over time rather than manually changing the model to account for these shifts.

Returning to FIG. 1, the system 100 also includes a user interface 160 and an analysis engine 165. The user interface 160 provides an interface to the system 100, allowing an operator to monitor in real-time the environmental system 110 and the environment within the man-made structure, and to review and analyze historical performance and predict future performance. The analysis engine 165 provides processing and analysis. Through the user interface 160, the operator can also make changes to the system profile 142. It may also allow the operator to configure different data inputs 131, 136, 137 and the data 112 from the environmental system, for example if components are taken offline or brought online.

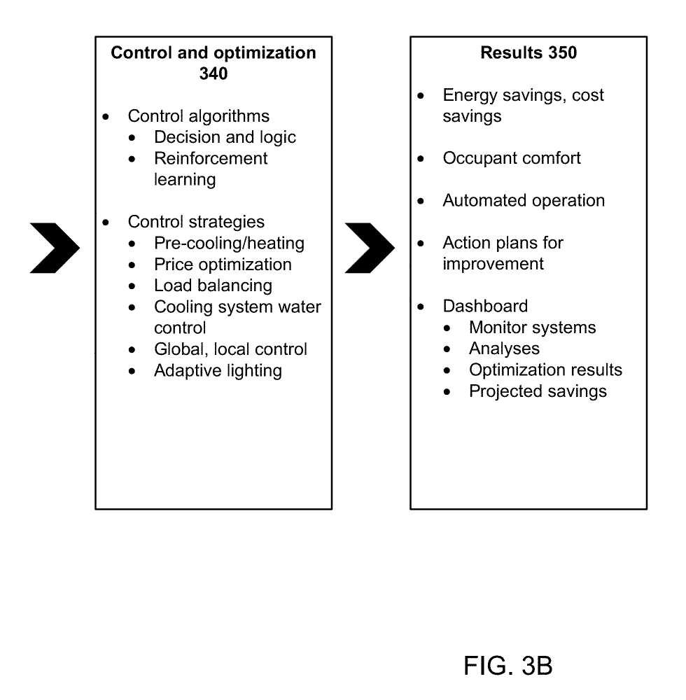

FIGS. 3A and 3B are a diagram illustrating a high-level flow for controlling an environmental system, according to an embodiment. FIG. 3B is a continuation of FIG. 3A. Whereas FIG. 1 illustrates control concepts in the form of a system block diagram, FIG. 3 organizes these concepts as a flow of data, actions and results. The input data 310 in FIG. 3A correspond to the inputs to the control system 150 in FIG. 1. The input data 310 includes sensor data 131 that characterizes the environment, data 136 for tracking occupants and other objects, data 137 from external sources, data 138 from occupants, operational data 112 from the environmental systems themselves, profile information 142 for the man-made structure and its occupants, and historical data 143. FIG. 3A lists examples of each of these categories, which were described previously with respect to FIG. 1.

The input data 310 is pre-processed 320. This can include data interpretation and data normalization. Examples of normalization include parsing data, error checking and correction, and transformation. Missing data may be retrieved or noted as missing. Duplicate data may be de-duped. Data from different sources may be aligned in time or space. Data may be reformatted to standardized formats used in further processing. Pre-processing 320 may also include data storage (e.g., in the history database 143), documentation and collection iteration. Documentation is the process of documenting the context of data, collection methodology, structure, organization, descriptions of variables and metadata elements, codes, acronyms, formats, software used, access and use conditions, etc. Collection iteration is the process of iteratively collecting new forms of data and/or improving previous data collection procedures to improve data quality.

Pre-processed data is analyzed 330. Analytics 152, 165 can be performed for purposes of controlling the environmental system or for purposes of analyzing the environmental system. Analysis can identify various patterns, as well as identifying areas of waste or potential improvement. As described above, machine learning 153 is especially useful to learn complex relationships and/or to automatically adapt to changes.

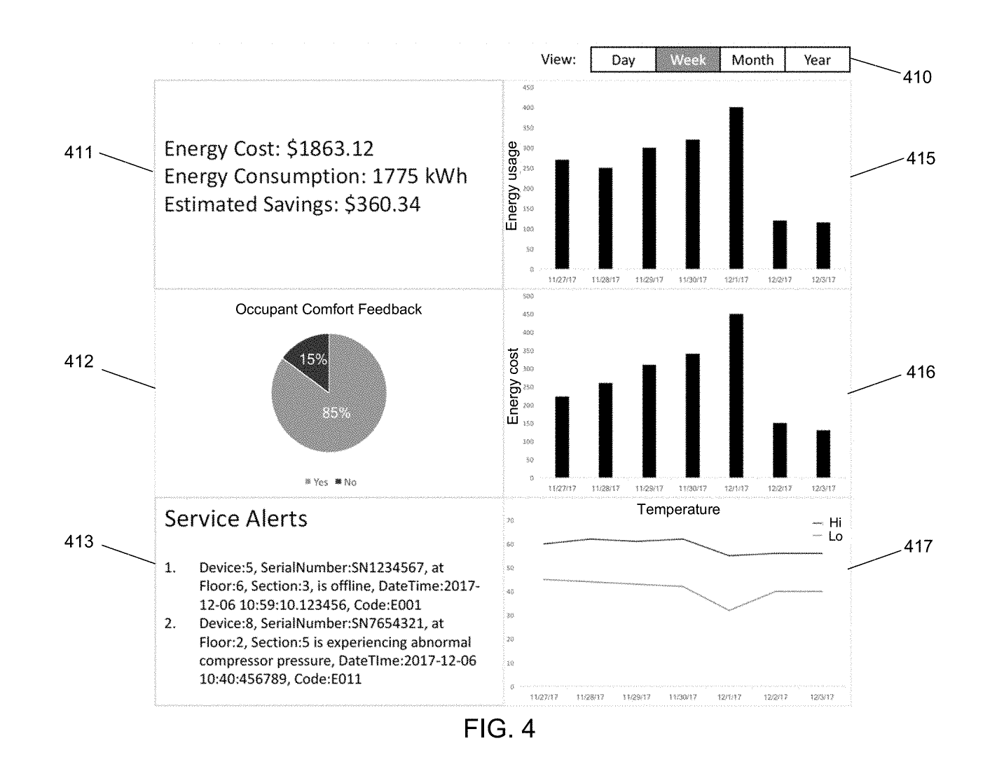

Visualization of analysis results is typically presented by the user interface 160. FIG. 4 is an example screen showing certain analysis results. Here, the operator has selected 410 to view weekly results. The six sections of the screen show different results. Section 411 shows the energy cost and consumption for the current week, and the estimated savings compared to a baseline. Section 412 shows that 85% of occupants have responded as being comfortable, for example using the mobile app of FIG. 2. Section 413 shows service alerts for equipment in the environmental system. Sections 415 and 416 show energy consumption and energy cost, respectively, for each day of the week. Section 417 shows the temperature range during the week. The top line is the high temperature and the bottom line is the low temperature.

Continuing to FIG. 3B, based on the analysis 330, different types of control and optimization 340 can be implemented. For more traditional control algorithms, the control is defined by a set of control logic or rules. Reinforcement learning can be used to adapt control strategies over time. FIG. 3B also lists some specific control strategies, such as pre-cooling or pre-heating individual spaces, optimizing price, load balancing the environmental system, controlling cooling water (e.g., adjusting temperature or flow rate), global vs local control as described previously, adaptive lighting, etc. Control and optimization may be performed based on machine learning results. For example, which rooms should be pre-heated or pre-cooled may be learned through machine learning analysis.

Box 350 lists some of the results and benefits that may be achieved. Improved control can result in energy and costs savings, and more occupant comfort. Automatic discovery of patterns and adaptation can result in a more automated operation of the environmental system. In cases where corrections are outside of what can be achieved by the control system, analysis can identify root causes and suggest an action plan to address the root causes. It may also be useful to produce a dashboard that gives an overview of operation of the environmental system.

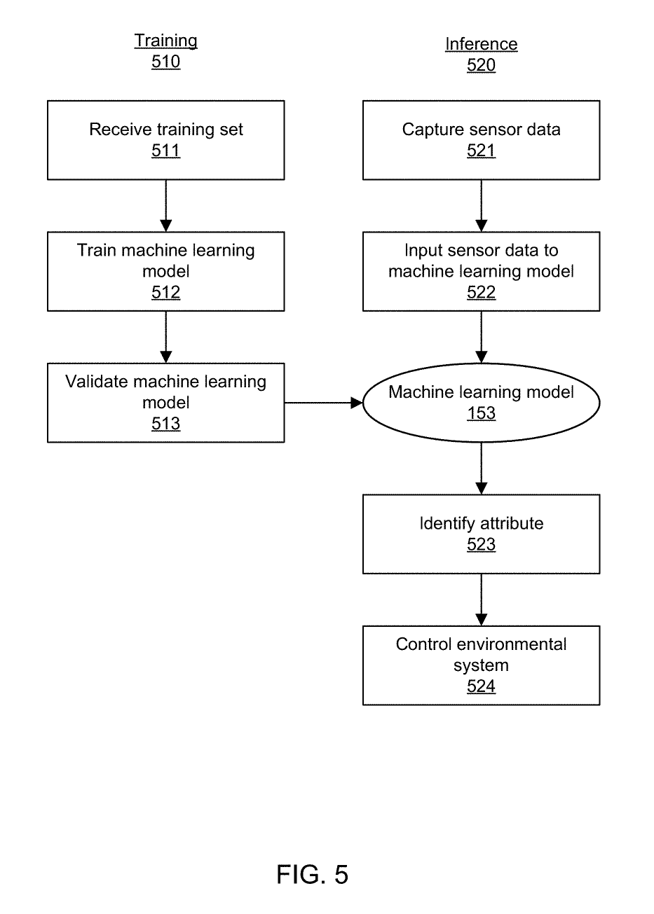

FIG. 5 is a flow diagram illustrating training and operation of a machine learning model 153, according to an embodiment. The process includes two main phases: training 510 the machine learning model 153 and inference (operation) 520 of the machine learning model 153. These will be illustrated using an example where the machine learning model learns to predict the environment in rooms (e.g., temperature, humidity, lighting) and the energy consumption/cost based on historical data. The following example will use the term “machine learning model” but it should be understood that this is meant to also include an ensemble of machine learning models.

A training module (not shown) performs training 510 of the machine learning model 153. In some embodiments, the machine learning model 153 is defined by an architecture with a certain number of layers and nodes, with biases and weighted connections (parameters) between the nodes. During training 510, the training module determines the values of parameters (e.g., weights and biases) of the machine learning model 153, based on a set of training samples.

The training module receives 511 a training set for training the machine learning model in a supervised manner. Training sets typically are historical data sets of inputs and corresponding responses. The training set samples the operation of the environmental system, preferably under a wide range of different conditions. FIG. 3A gives some examples of input data 310 that may be used for a training set. The corresponding responses are observations after some time interval, such as the actual temperature and humidity achieved, energy consumed and cost during the time interval, occupant comfort feedback, etc.

The following is an example of a training sample:
Day of week: Monday
Time of day: 12:00 pm
Outdoor temperature: 90 F
Outdoor humidity: 80%
Indoor temperature: 85 F
Indoor humidity: 80%
Number of occupants: 20
Size of target area: 500 sq. feet
System is set to reach: 75 F

After 30 minutes, the environmental system has done some work and at 12:30 pm the observed responses are the following:
Indoor temperature: 80 F
Indoor humidity: 50%
Energy consumed: 100 kWh
Energy cost: $100
   In typical training 512, a training sample is presented as an input to the machine learning model 153, which then predicts an output for a particular attribute. The difference between the machine learning model's output and the known good output is used by the training module to adjust the values of the parameters (e.g., features, weights, or biases) in the machine learning model 153. This is repeated for many different training samples to improve the performance of the machine learning model 153 until the deviation between prediction and actual response is sufficiently reduced.

The training module typically also validates 513 the trained machine learning model 153 based on additional validation samples. The validation samples are applied to quantify the accuracy of the machine learning model 153. The validation sample set includes additional samples of inputs and known responses. The output of the machine learning model 153 can be compared to the known ground truth. To evaluate the quality of the machine learning model, different types of metrics can be used depending on the type of the model and response.

Classification refers to predicting what something is, for example if an image in a video feed is a person. To evaluate classification models, F1 score may be used. Regression often refers to predicting quantity, for example, how much energy is consumed. To evaluate regression models, coefficient of determination may be used. However, these are merely examples. Other metrics can also be used. In one embodiment, the training module trains the machine learning model until the occurrence of a stopping condition, such as the metric indicating that the model is sufficiently accurate or that a number of training rounds having taken place.

Training 510 of the machine learning model 153 can occur off-line, as part of the initial development and deployment of system 100. The trained model 153 is then deployed in the field. Once deployed, the machine learning model 153 can be continually trained 510 or updated. For example, the training module uses data captured in the field to further train the machine learning model 153. Because the training 510 is more computationally intensive, it may be cloud-based.

In operation 520, the machine learning model 153 uses the same inputs as input 522 to the machine learning model 153. The machine learning model 153 then predicts the corresponding response. In one approach, the machine learning model 153 calculates 523 a probability of possible different outcomes, for example the probability that a room will reach a certain temperature range. Based on the calculated probabilities, the machine learning model 153 identifies 523 which attribute is most likely. In a situation where there is not a clear cut winner, the machine learning model 153 may identify multiple attributes and ask the user to verify.

Continuing the above example, a team of office workers come back from lunch, and join a meeting from 1:00 pm to 2:00 pm, in a conference room where the air conditioning has previously been turned off because there has not been anyone in the room for the day. They enter the room and turn on the air conditioning at 1:00 pm. The environmental system defaults to an auto cooling mode of 76 F. The inputs to the machine learning model 153 are the following:
Day of week: Tuesday
Time of day: 1:00 pm
Outdoor temperature: 95 F
Outdoor humidity: 80%
Conference room temperature: 85 F
Conference room humidity: 80%
Number of occupants: 40
Conference room area: 800 sq. feet
System is set to reach: 76 F
   The machine learning model 153 predicts the following attributes 155:
Predicted conference room temperature at 2 pm
Predicted energy consumed during the hour from 1 pm to 2 pm
Predicted cost of the consumed energy
   The controller 159 controls 524 the environmental system by using the responses predicted by the machine learning model 153 to make informed decisions.

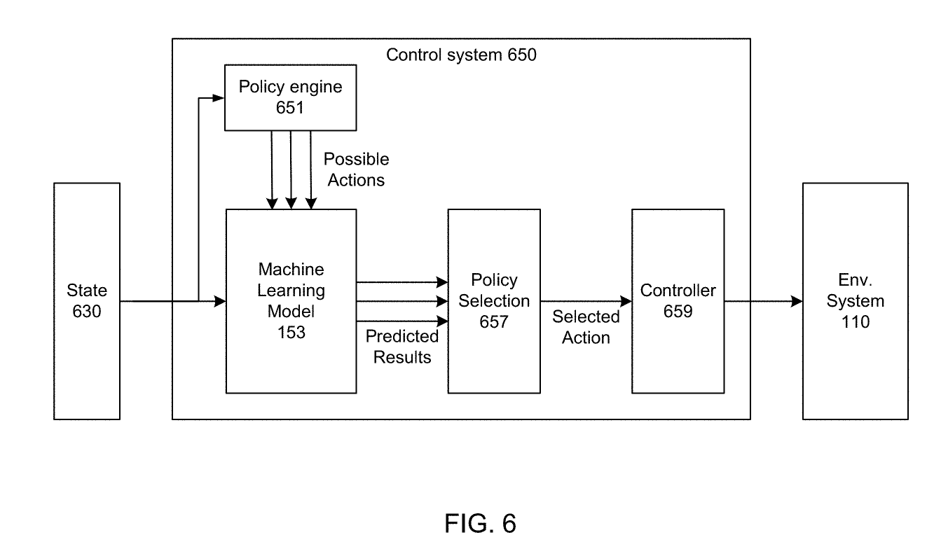

FIG. 6 is a block diagram of a control system 150 that uses the machine learning model 153 to evaluate different possible courses of action. In this example, the machine learning model 153 functions as a simulation of the environmental system 110 and the man-made structure with respect to the inputs and responses of interest. The current state 630 of the environment and system are the inputs to the machine learning model 153. For example, the state might include the room temperature being 85 F, humidity being 80%, number of people being 40, outdoor temperature being 95 F, etc. The control system 150 can take different courses of action to affect the environment. For example, the control system can set the temperature, change the fan speed, change the mode of operation, or it can do nothing and keep the current settings.

A policy is a set of actions performed by the control system 150. In the above scenario, some example policies are as follows:
Policy 1: Turn on air conditioning for the conference room only when people are detected inside. Attempt to cool the room as quickly as possible to comfort zone temperature, and turn off when occupants leave.
Policy 2: Keep conference room air conditioned at comfort zone temperatures for the duration of working hours.
Policy 3: Pre-cool conference room gradually to comfort zone temperature prior to occupant arrival.

The policies can be a set of logic and rules determined by domain experts. They can also be learned by the control system itself using reinforcement learning techniques. At each time step, the control system evaluates the possible actions that it can take and chooses the action that maximizes evaluation metrics. It does so by simulating the possible subsequent states that may occur as a result of the current action taken, then evaluates how valuable it is to be in those subsequent states. For example, a valuable state can be that the resulting temperature of the target space is within the comfort zone and that energy consumption to reach such temperature is minimal.

Based on the current state 630, a policy engine 651 determines which polices might be applicable to the current state. This might be done using a rules-based approach, for example. The machine learning model 153 predicts the result of each policy. The different results are evaluated and a course of action is selected 657 and then carried out by the controller 659. A set of metrics is used to evaluate the policies. For example, if the comfort zone is defined as being within a range of temperatures and humidity, then a policy that results in actual temperatures outside the comfort zone for too long when occupants are present is scored poorly. A policy that results in a high volume of occupant complaints is scored poorly. Other example metrics include the energy consumption and monetary cost to perform a policy. A policy that results in high energy consumption or high cost is scored poorly.

Metrics can be defined to suit particular needs. For example, metrics to evaluate policies that manage server rooms may be different from policies that manage conference rooms. Metrics can also be defined for different time horizons. For example, a policy may be chosen to optimize for immediate gains, while another may be chosen to optimize for long-term benefits. In this example, Policy 1 keeps the air conditioner off unless occupants are present, thus optimizing for the immediate conditions. In contrast, Policy 3 pre-cools the conference room gradually in advance, so that it does not have to operate at full capacity or consume excessive energy later on. Depending on the business goals, different time horizons can be defined for different systems, and the metrics are adjusted accordingly.

To simulate subsequent states, the control system 150 uses the trained machine learning model 153. When underlying conditions (e.g. weather) are changing, the machine learning model 153 can make predictions on what most likely will be observed as a result of actions taken. Based on these predictions, the control system 150 chooses a policy or action that most likely maximizes the metric of interest. In this example scenario, the optimal policy may be Policy 3, where the control system pre-cools the conference room gradually throughout the morning, such that it achieves optimal comfort for occupants when they arrive but it does not consume excessive energy to operate at full capacity at peak demand and does not operate after occupants leave.

To decide which action to take from a state, the control system 150 may employ techniques of exploitation and exploration. Exploitation refers to utilizing known information. For example, a past sample shows that under certain conditions, a particular action was taken, and good results were achieved. The control system may choose to exploit this information, and repeat this action if current conditions are similar to that of the past sample.

Exploration refers to trying unexplored actions. With a pre-defined probability, the control system may choose to try a new action. For example, 10% of the time, the control system may perform an action that it has not tried before but that may potentially achieve better results.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A method implemented on a computer system for controlling an environmental system for a man-made structure, the method comprising:
receiving environmental data collected by sensors for an environment within the man-made structure;
using the environmental data as input to a machine learning model that predicts at least one attribute affecting control of the environment within the man-made structure; and
controlling the environmental system for the man-made structure based on the predicted attribute.

2. The computer-implemented method of claim 1 wherein the environmental system being controlled includes at least one of a heating system, a ventilation system, a cooling system, an air circulation system, an artificial lighting system, a system for regulating light entering the man-made structure from external surroundings and a system for regulating heating and/or cooling of the man-made structure by the external surroundings.

3. The computer-implemented method of claim 1 wherein the man-made structure includes at least one of a commercial building, a public building and a building with at least 20 rooms.

4. The computer-implemented method of claim 1 wherein the environmental data includes at least one of a temperature within the environment, a humidity within the environment, an air quality within the environment, a lighting level within the environment, and a lighting color within the environment.

5. The computer-implemented method of claim 1 further comprising:
receiving feedback about the environment from occupants of the man-made structure; and
using the feedback as additional input to the machine learning model.

6. The computer-implemented method of claim 5 wherein the feedback is received from mobile apps on mobile devices operated by the occupants.

7. The computer-implemented method of claim 5 wherein the feedback is feedback whether the occupant is satisfied with the current environment.

8. The computer-implemented method of claim 1 further comprising:
receiving data relating to objects inside the man-made structure; and
using the data relating to objects as additional input to the machine learning model.

9. The computer-implemented method of claim 8 wherein the machine learning model identifies objects in the man-made structure, and controlling the environmental system is further based on tracking locations of the objects.

10. The computer-implemented method of claim 1 further comprising:
receiving data relating to occupants inside the man-made structure; and
using the data relating to occupants as additional input to the machine learning model, wherein the machine learning model identifies occupants in the man-made structure.

11. The computer-implemented method of claim 10 wherein the data relating to occupants includes images received from cameras.

12. The computer-implemented method of claim 10 wherein the data relating to occupants includes at least one of locations of occupants received from physical access ways in the man-made structure, and movements of occupants received from trackable objects carried by the occupants.

13. The computer-implemented method of claim 10 wherein controlling the environmental system is further based on preferences of the occupants.

14. The computer-implemented method of claim 1 further comprising:
accessing historical data and using the historical data as additional input to the machine learning model.

15. The computer-implemented method of claim 1 further comprising:
accessing information from external sources for factors that affect the environment and/or operation of the environmental system and using the information from external sources as additional input to the machine learning model.

16. The computer-implemented method of claim 15 wherein said information includes at least one of a weather forecast for the external surroundings of the man-made structure, a rate schedule for resources consumed by the environmental system, and a forecasted demand for resources that are also consumed by the environmental system.

17. The computer-implemented method of claim 1 wherein controlling the environmental system comprises:
controlling the environmental system to provide a general background environment for the man-made structure; and
further controlling the environmental system to deviate from the general background environment based on specific conditions occurring in the man-made structure.

18. The computer-implemented method of claim 1 further comprising:
receiving operational data from the environmental system; wherein controlling the environmental system is further based on the operational data from the environmental system.

19. The computer-implemented method of claim 1 further comprising:
accessing profile information for the man-made structure; wherein controlling the environmental system is further based on the profile information.

20. A system for controlling an environmental system for a man-made structure, the system comprising:
an input module that receives environmental data collected by environmental sensors for an environment within the man-made structure;
a machine learning model that receives the environmental data as input and predicts one or more attributes of the environment within the man-made structure; and
a controller that controls the environmental system for the man-made structure based on the predicted attributes.
